(19) United States
(12) Patent Application Publication
(10) Pub. No.: US 2002/0179364 A1
(43) Pub. Date: Dec. 5, 2002

(54) Apparatus and methods for using a surface oscillator as a downhole seismic source

(75) Inventors: Terry R. Bussear, Round Rock, TX (US); Michael W. Norris, Cypress, TX (US)

Correspondence Address: PAUL S MADAN, MADAN, MOSSMAN & SRIRAM, PC, 2603 AUGUSTA, SUITE 700, HOUSTON, TX, 77057-1130, US

(73) Assignee: Baker Hughes Incorporated, Houston, TX (US)

(21) Appl. No.: 10/047,728

(22) Filed: Jan. 15, 2002

Related U.S. Application Data
(60) Provisional application No. 60/262,992, filed on Jan. 19, 2001.

(51) Int. Cl. G01V 1/00

(52) U.S. Cl. 181/108; 181/113; 181/122

(57) ABSTRACT

A system and method for utilizing a surface located oscillator to generate seismic signals at a downhole location. The system includes a vibratory source for generating axial vibrational energy in a tubular string anchored in the borehole at a suitable location. The vibratory source may be operated at a predetermined frequency or may generate a swept frequency signal. The axial vibrations are transmitted through the tubular string and impart a seismic signal through the anchor to the formation.. In different configurations, the system imparts broadband seismic signals into the formation. Sensors are mounted on the vibratory source and downhole anchor for monitoring the system operation. Seismic receivers are deployed on the surface, in offset wells, or in the source well. Signals from the receivers are transmitted to a control unit. The control unit utilizes the sensor and receiver signals to control the operation of the vibratory source.

This application claims priority from U.S. Provisional Application No. 60/262,992 filed on Jan. 19, 2001.

### BACKGROUND OF THE INVENTION

1. Field of the Invention

The present invention relates to the field of acquiring seismic data and in particular to a system for acquiring seismic data using a surface actuated downhole source.

2. Description of the Related Art

Downhole seismic sources are used to determine the geological characteristics of the underground strata surrounding the borehole. The objective of such sources is to create seismic waves which propagate into the surrounding formation. Receivers, such as geophones, detect the seismic waves after they have traveled through the geologic strata. Processing of these received waves can be used to determine the characteristics of the geologic formation including those of the various reflecting strata interfaces.

Various receiver techniques are used with downhole seismic sources. These techniques include placing the receivers in adjacent offset wells, also known as cross-well tomography. In another technique, the receivers are placed on the surface of the ground to detect the downhole generated signal. This is also known as reverse vertical seismic profiling (“RVSP”). In another technique, the receivers are co-located in the same wellbore as the downhole seismic source.

Conventional downhole seismic sources are usually suspended down a borehole from a cable which also provides power to operate the source and conveys various sensor signals associated with the source back to the surface. The electrical driving power available to such devices is usually limited to a few kilowatts by cable constraints. This power constraint limits the available downhole signal strength and produces signals which have limited detectable range within the formation. These sources are typically driven at their maximum power levels to maximize the transmission distance. In addition, these sources do not use the received signals in a closed-loop system to adjust the generated signal to maximize the received signal. Thus there is a need for a seismic system which can generate sufficient power downhole to extend the detectable range of the generated signals. This system should be capable of working in a standalone, open-loop manner and in a closed-loop manner utilizing the received signals to adjust the generated signal to maximize the detection range.

### SUMMARY OF THE INVENTION

The present invention provides an improved system for generating downhole seismic signals by overcoming previous limitations as to received signal strength and closed loop control of the vibratory source to maximize the received signal.

In one embodiment of the invention, a vibratory source is coupled by a tubular string to a downhole anchor. The vibratory source is powered by a power source which can be a hydraulic, electric, or pneumatic system. Load and motion sensors are mounted on the tubular string both downhole and at the surface, and provide signals to a surface control unit for use in feedback control of the vibratory source. Seismic sensors, such as geophones, may be deployed on the surface, in offset wells, or in the same well as the source. These signals are transmitted back to the control unit and may be used to control the vibratory source so as to maximize the received signals.

In another embodiment, the surface vibratory source imparts axial motion to a tubular string which is attached to a downhole hammer apparatus such that axial motion of the tubular string causes the downhole hammer to impart a broadband signal which is transmitted into the surrounding reservoir formation.

In one aspect of the invention a method of generating a downhole seismic signal in a wellbore is presented which comprises (i) providing a vibratory source at a surface location; (ii) coupling the vibratory source to the upper end of a tubular string, anchoring the tubular string at a selected downhole location; and (iii) operating the vibratory source in an axial vibration mode to cause axial vibratory displacement of the upper end of the tubular string thereby transmitting the vibrational motion to the anchor and inducing a seismic signal into the surrounding formation.

An alternative method comprises (i) measuring parameters of interest and transmitting the measurements to the surface control unit; and (ii) controlling the vibratory source base d on the measurements of the parameters of interest.

Example s o f the more important features of the invention have been summarized rat her broadly in order that the detailed description thereof that follows may be better understood, and in order that the contributions to the art may be appreciated. There are, of course, additional features of the invention that will be described hereinafter and which will form the subject of the claims appended hereto.

### BRIEF DESCRIPTION OF THE DRAWINGS

For detailed understanding of the present invention, references should be made to the following detailed description of the preferred embodiment, taken in conjunction with the accompanying drawings, in which like elements have been given like numerals and wherein:

FIG. 1 is a schematic illustration of a system for generating downhole seismic waves in a reservoir according to one embodiment of the present invention; and

FIG. 2 is a alternative arrangement of a downhole seismic source according to the present invention.

### DESCRIPTION OF THE PREFERRED EMBODIMENTS

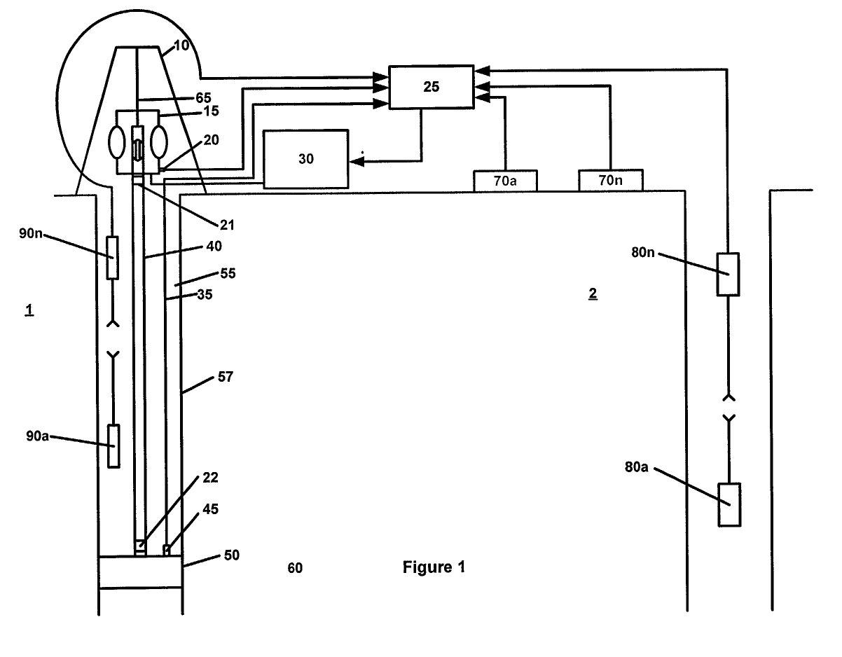

Referring to FIG. 1, the system is schematically illustrated. The vibratory source 15 is attached to support cable 65 and supported by support derrick 10. The vibratory source 15 is clamped to the upper, free end of tubular string 40. The tubular string 40 extends down the wellbore 55 to a location where it is desired to generate seismic waves in the reservoir formation 60. The tubular string 40 has an anchor 50 attached to the downhole end of the tubular string 40. A number of commercially available devices can serve as the anchor 50, including, but not limited to, a resettable packer, a resettable and retrievable bridge plug, a tubing hanger, or any other suitable device known in the art. The anchor 50 is activated at the desired downhole location so that the lower end of the tubular string 40 is essentially constrained from moving axially. Axial oscillation of the upper, free end of tubular string 40 is vibrationally transmitted down tubular string 40 to the constrained lower end and is transferred through the anchor 50 as primarily shear waves into the reservoir formation 60. The anchor 50 may be retrieved and reset at multiple downhole locations to provide seismic input to the formation at multiple locations.

Alternatively, multiple fixed anchors(not shown), such as a tubing hanger, may be permanently located at multiple locations in the wellbore 55 to provide a known location for taking seismic data at different times for comparison and analysis of formation properties over time.

The surface located vibratory source 15 is powered by power source 30 which is controlled by a control unit 25. The control unit 25 contains a processor (not shown) which may be may be a microprocessor, a microcomputer, or a computer with suitable capability to accept sensor inputs and provide output control signals. The control unit 25 may also have mass data storage capacity. Such devices are well known in the art and are not described further.

Vibration sensor 20 is mounted on the vibratory source 15 and generates signals proportional to the vibrational motion of the vibratory source 15 which are transmitted to control unit 25. Load sensor 21 is inserted in the tubular string 40 near the surface. Load sensor 21 generates signals proportional to the vibration force and the static force imposed on the tubular string 40 by the motion of the vibratory source 15 and by the weight of the tubular string 40.

Vibration sensor 45 is mounted proximate the downhole anchor 50 and measures the characteristics of the downhole vibration imparted to anchor 50 and thus to the reservoir 60.

Signals from the vibration sensor 45 are transmitted to the surface control unit 25 via sensor cable 35 which may be an instrument cable, a standard wireline logging cable, an optical cable or a combination cable having both electrical and optical capabilities. Alternatively, the signals from vibration sensor 45 can be transmitted by acoustic or electromagnetic techniques known in the art.

Load sensor 22 is inserted in tubular string 40 proximate to anchor 50 and measures the tension and compression loads imparted to the anchor 50 due to the vibratory motion of and weight of the tubular string 40. Signals from the load cell are transmitted to the surface control unit 25 via sensor cable 35. Alternatively, the signals from load sensor 22 can be transmitted by acoustic or electromagnetic techniques to the control unit 25.

The control unit 25 is programmed to compare the signals from the surface vibration sensor 20 and the downhole vibration sensor 45 and signals from the upper load sensor 21 and the lower load sensor 22 to determine the transmissibility of power from the vibratory source 15 to the anchor 50.

Seismic receivers 70a-70n are mounted on the surface at a distance from the source borehole 1. These receivers are typically geophones known in the art and sense the seismic signals imparted to the formation 60 by the system in borehole 1. The receivers 70a-70n may be deployed in predetermined patterns on the surface to best determine the subsurface characteristics. The signals from receivers 70a-70n are transmitted to the control unit 25.

Seismic receivers 80a-80n are deployed in an offset borehole 2 and sense the seismic signals at different depths in the offset borehole. The signals from receivers 80a-80n are transmitted to control unit 25. There may be multiple sets of receivers 80a-80n deployed in multiple offset boreholes proximate the source borehole 1.

The signals from the receivers 70a-70n and 80a-80n may be processed either separately or together by the control unit 25 and the results used to modify the operation of the vibratory source 15 so as to improve the signal at the receivers 70a-70n and 80a-80n. Such modifications include but are not limited to changing the frequency of the vibratory source 15 and changing the vibration amplitude of source 15.

In a preferred embodiment referring to FIG. 1, the surface vibratory source 15 is a hydraulically driven device, such as Product No. 140-52 of Baker Oil Tools, a division of Baker Hughes Incorporated. This device is also described in U.S. Pat. No. 5,234,056, which is incorporated herein by reference. Such a device provides a highly elastic support so as to provide for a very low impedance to vibration at the upper end of tubular string 40. This vibratory source 15 is designed to vibrationally isolate the tubular string 40 from the support derrick 10. This vibratory source 15 can provide a typical surface axial displacement of 1 to 2 inches.

In this embodiment, the power source 30 is a servo-controlled hydraulic system which can be controlled by the control unit 25 to vary the hydraulic fluid flow rate to the vibratory source 15 causing the vibratory source 15 to vibrate at a rate proportional to the flow rate thereby varying the frequency of axial vibration. The measurements of load from load sensors 21 and 22, and of vibratory motion from vibration sensors 20 and 45 are transmitted to the control unit 25. The load and vibration data are used to determine the power transmissibility from the surface to the downhole location. The load data is also used to limit the amplitude of vibration to safe levels. The control unit 25 also receives data from receivers 70a-70n and/or 80a-80n. This receiver data is used to modify the source signal so as to maximize the signal at the receivers. The source signal may be modified in a closed-loop real time mode or alternatively, the data may be processed and the source signal modified sequentially. The receiver signals may also be stored in memory or on permanent storage media for later processing.

In a preferred embodiment the control unit 25 may be programmed to generate a single frequency or alternatively it may be programmed to generate a swept frequency signal.

In another embodiment the signals from the same well receivers 90a-90n are transmitted to the control unit 25 and these signals are used to modify the source signal to maximize the signal received by 90a-90n. The signals from receivers 90a-90n may also be stored in memory by the control unit 25. Those received signals may also be stored, in either analog or digital form, on permanent storage media suitable for retrieval and subsequent processing.

In yet another embodiment, the receiver signals are transmitted to a separate data storage system (not shown) for storage. The control unit 25 according to programmed instructions, uses signals from the load cells 21 and 22 and the vibration sensors 20 and 45 to control the source signal.

In still another embodiment, the source signal is controlled manually. The load sensors 21 and 22 and the vibration sensors 20 and 45 use stand-alone power and display readouts (not shown). The operator manually controls the vibratory source 15.

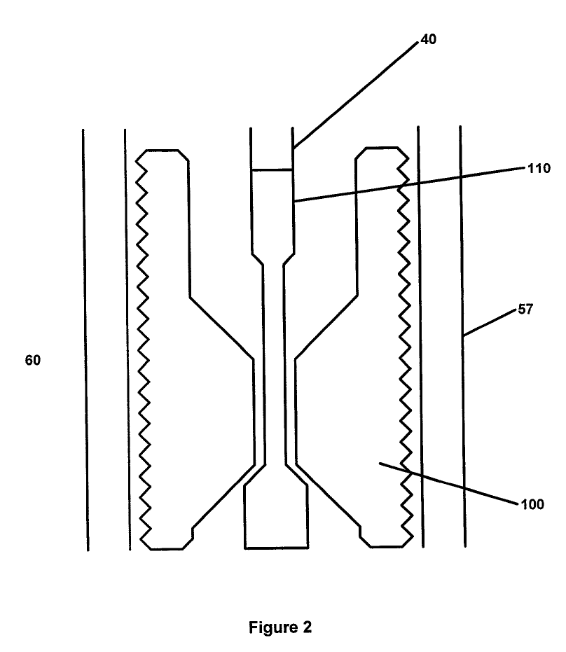

An alternative anchor embodiment is shown in FIG. 2, where the tubular string 40 is not axially fixed in the downhole location, but instead uses the cyclical axial motion to impact an anchored anvil to generate broadband seismic waves in the formation. The operation of the equipment on the surface is essentially the same. A slip anvil 100 is anchored to the borehole. The slip anvil 100 may be installed with techniques generally known in the art. The driver 110 is attached to the bottom of tubular string 40 and moves axially with tubular string 40. The driver 110 can be of a two-piece construction (not shown) so as to allow assembly with the anvil 100. The driver 110 has tapered sections at each end of a reduced cross-section, such that each of the tapered sections alternatively impact corresponding sections of the anvil 100 as the tubular string moves alternatively up and down in response to the motion of the surface vibratory source 15. The driver 110 creates axial and radial impact forces which are coupled through the slip anvil 100 into the reservoir formation 60 as seismic waves. These seismic waves project a broadband signal into the formation.

In one aspect of the invention a method for generating and receiving seismic waves is presented which includes the steps for (i) attaching a surface mounted vibratory source to a tubular string in a borehole; (ii) controlling the vibratory source with a surface control system and a programmed processor; (iii) anchoring the tubular string to the wellbore at one or more locations downhole; (iv) operating the vibratory source to generate seismic waves which propagate into the surrounding formation; (v) measuring the load on the tubular string at the surface and proximate the anchor; (vi) transmitting load and motion data to the processor; (vii) locating seismic receivers on the surface, in offset wells, or in the borehole with the source; (viii) transmitting the receiver data to the processor; and (ix) operating the processor, according to programmed instructions, to use the load data, the vibrational motion data, and the receiver data in a closed loop control mode to adjust the vibratory source in order to maximize the received signals

The foregoing description is directed to particular embodiments of the present invention for the purpose of illustration and explanation. It will be apparent, however, to one skilled in the art that many modifications and changes to the embodiments set forth above are possible without departing from the scope and the spirit of the invention. It is intended that the following claims be interpreted to embrace all such modifications and changes.

What is claimed is:

1. An apparatus for inducing seismic energy in a formation penetrated by a borehole, comprising:
an anchor device engaged with the borehole at a selected location; and
a vibratory source at a surface location coupled to the anchor causing the anchor to impart seismic energy into the formation.

2. The apparatus of claim 1, further comprising a power source to drive the vibratory source.

3. The apparatus of claim 1, wherein the power source is selected from a group consisting of (i) a hydraulic unit; (ii) an electrically-operated device; and (iii) a pneumatic device.

4. The apparatus according to claim 1, further comprising at least one sensor to provide a measure of a parameter of interest.

5. The apparatus of claim 4, wherein the parameter of interest is one of (i) motion of the anchor; (ii) load on the anchor; (iii) load on a tubular string coupled between the anchor and the vibratory source; and (iv) motion of the tubular string.

6. The apparatus of claim 1 further comprising:
a first sensor proximate the anchor to measure a selected parameter of interest; and
a second sensor spaced-apart from the first sensor measuring the parameter of interest to determine transmissibility of power from the vibratory source to the anchor.

7. The apparatus of claim 6, wherein the parameter of interest is one of (i) motion of the anchor; (ii) load on the anchor; (iii) load on a tubular string coupled between the anchor and the vibratory source; and (iv) motion of the tubular string.

8. The apparatus of claim 5 further comprising a control unit to control the operation of the vibratory source.

9. The apparatus of claim 8, wherein the control unit includes a computer.

10. The apparatus of claim 8, wherein the control unit controls frequency of operation of the vibratory source in response to the sensed parameter of interest.

11. The apparatus of claim 10, wherein the control unit controls frequency in accordance with programmed instructions provided to the control unit.

12. A system for obtaining seismic data, comprising:
an anchor device engaged with the borehole at a selected location; and
a vibratory source at a surface location coupled to the anchor causing the anchor to induce seismic energy into the formation.
at least one detector placed spaced-apart from the anchor, to detect seismic signals responsive to the seismic energy imparted in the formation by the anchor.

13. The system of claim 12 further comprising a control unit to control the vibratory source.

14. The system of claim 13, wherein the control unit controls the vibratory source in response to the signals detected by the at least one detector.

15. The system of claim 12, wherein the at least one detector is placed at a location selected from one of (i) surface location; (ii) a location in the borehole; (iii) a secondary borehole formed spaced-apart from the borehole; or (iv) a secondary borehole that forms a part of a multibore system containing the borehole.

16. The system of claim 12, wherein the at least one detector includes a plurality of spaced apart detectors.

17. The system of claim 12, wherein said control unit processes the signals detected by at least one detector.

18. A method for inducing seismic energy in a formation penetrated by a borehole, comprising:
coupling a tubular string between a downhole anchor and a surface vibratory source;
vibrating the tubular string to generate a seismic wave in the formation at the anchor.

19. The method of claim 18 further comprising for providing at least one sensor measuring a parameter of interest, wherein the parameter of interest is one of (i) load on the anchor; (ii) load on the tubular string proximate the vibratory source; (iii) vibratory motion of the anchor; or (iv) vibratory motion of the tubular string proximate the vibratory source.

20. The method of claim 19 further comprising controlling the frequency of operation of the vibratory source with a control unit, said control unit having a processor acting according to programmed instructions, said control unit controlling the frequency of the vibratory source in response to the sensed parameter of interest.

21. The method of claim 17 further comprising providing a first sensor proximate the anchor to measure a selected parameter of interest and a second sensor spaced-apart from the first sensor, said second sensor measuring the same parameter of interest for determining transmissibility of power from the vibratory source to the anchor.

22. The method of claim 21, wherein the parameter of interest is one of (i) motion of the anchor; (ii) load on the anchor; (iii) load on a tubular string coupled between the anchor and the vibratory source; and (iv) motion of the tubular string.

23. A method for obtaining seismic data, comprising:
engaging an anchor in a wellbore in a subsurface formation at a selected downhole location;
coupling the anchor to a surface located vibratory source;
energizing the vibratory source to impart seismic energy through the anchor to the formation; and
sensing the seismic energy by at least one detector spaced-apart from the anchor.

24. The method of claim 23, further comprising controlling the vibratory source with a control unit.

25. The method of claim 23, further comprising controlling the vibratory source with a control unit in response to the signals sensed by the at least one detector.

26. The method of claim 23, wherein the at least one detector is placed at a location selected from one of (i) surface location; (ii) a location in the borehole; (iii) a secondary borehole formed spaced-apart from the borehole; or (iv) a secondary borehole that forms a part of a multibore system containing the borehole.
